(19) United States
(12) Patent Application Publication
(10) Pub. No.: US 2022/0358151 A1
(43) Pub. Date: Nov. 10, 2022

(54) Resource-Efficient Identification of Relevant Topics based on Aggregated Named-Entity Recognition Information

(71) Applicant: Microsoft Technology Licensing, LLC, Redmond, WA (US)

(72) Inventors: Homa BARADARAN HASHEMI, Kirkland, WA (US); Wenjin XU, Bothell, WA (US); Hui LI, Bellevue, WA (US)

(73) Assignee: Microsoft Technology Licensing, LLC, Redmond, WA (US)

(21) Appl. No.: 17/316,640

(22) Filed: May 10, 2021

(51) Int. Cl. G06F 16/332; G06F 16/33; G06F 16/955; G06F 40/295; G06N 20/20; G06N 3/04

(52) U.S. Cl. CPC G06F 16/3326; G06F 16/3347; G06F 16/9558; G06F 40/295; G06N 20/20; G06N 3/04

(57) ABSTRACT

A topic-processing system processes topics in a set of documents in a two-stage manner. In the first stage, the system recognizes candidate topics in the set of documents using a machine-trained named-entity recognition (NER) model, to produce original NER information. In a second stage, the system aggregates the original NER information over the set of documents, to produce aggregated information. The system then ranks the candidate topics in the set of candidate topics based on the aggregated information using a machine-trained classification model, to produce a set of ranked topics. The system then selects a set of final topics from the set of ranked topics, e.g., by excluding ranked topics having scores below a prescribed threshold value. A production system presents supplemental information regarding selected final topics, where those final topics are identified by the topic-processing system.

### BACKGROUND

A Named-Entity Recognition (NER) model identifies named entities within a passage of text. A named entity most often refers to a proper name within the text, e.g., associated with the name of a person, organization, location, event, project, etc. While NER models are in widespread use across different kinds of knowledge mining and natural language processing applications, the training processes used to produce these models may suffer from various technical inefficiencies. Likewise, the production systems that use the trained models may exhibit various technical shortcomings.

### SUMMARY

Technology is described herein for processing topics in a set of documents in a two-stage manner. In the first stage, the technology recognizes candidate topics in the set of documents using a machine-trained named-entity recognition (NER) model, to produce original NER information. The original NER information describes topic names that appear in the set of documents and the properties of these topics names (e.g., by describing the distribution of entity types associated with each topic name). In a second stage, the technology aggregates the original NER information over the set of documents, to produce aggregated information. The technology then ranks the candidate topics in the set of candidate topics based on the aggregated information, using a machine-trained classification model. This operation yields a set of ranked topics. The technology then selects a set of final topics from the set of ranked topics, e.g., by excluding ranked topics having scores below a prescribed threshold value.

In some implementations, the set of documents processed by the technology pertains to a diverse collection of documents maintained and utilized by a particular enterprise, such as a particular company.

In some implementations, the technology links each final topic to supplemental information. For example, the technology can link a topic name associated with a particular final topic with a topic page that provides supplemental information regarding the particular final topic. A production system is configured to present the topic page when the user selects the topic name within a particular document.

In some implementations, the aggregated information is expressed by plural features for each particular topic name, associated with a particular candidate topic. Without limitation, one or more features may depend on the distribution of entity types associated with the particular topic name across the set of documents. One or more features may depend on a frequency at which the particular topic name appears in the set of documents. One or more features may depend on a manner in which users have interacted with documents that include the particular topic name. One or more features may depend on lexical characteristics of the particular topic name, and so on.

A production system is also described herein for presenting supplemental information regarding the final topics that have been produced using the knowledge-mining process described above.

According to one technical characteristic, the technology provides a technique for improving the relevance of topics presented to users in a production system. Stated in the negative, the technology reduces the amount of low-relevance noisy topics presented to the user. The technology performs this task by extracting insight from the distribution of the original NER information across the entire set of documents.

The technology also reduces the amount of system resources that are required to process the final topics (relative to the original number of candidate topics). This is because the final set of topics is smaller than the original set of candidate topics, and it requires fewer resources to process a smaller set of topics compared to a larger set of topics. For instance, the technology reduces the number of topic pages that need to be generated for the identified topics, and reduces the system resources that are required to present the topic pages to users. System resources include memory resources, storage resources, processing resources, communication resources, etc.

In the production system, the technology can reduce the number of annotations that it presents associated with identified topics. This system behavior facilitates the user's interaction with a document, e.g., by not overwhelming the user with too many low-value annotations. The technology also reduces the amount of system resources that are necessary to produce the annotations and to process the user's interaction with the annotations.

The technology also allows its machine-trained models to be trained in a time-efficient and resource-efficient manner. For example, the technology provides a general-purpose and scalable way of gauging the importance of topics within many different types of enterprise environments. The technology thereby eliminates or reduces the practice of manually developing a set of idiosyncratic features and heuristic rules that describe the unique characteristics of a particular enterprise's documents and the interests of its members. It similarly simplifies the task of updating a machine-trained model to account for changes within an enterprise. By providing a process for accurately discriminating between relevant and less-relevant topics, the technology may also decrease the amount of time and system resources that are required to train its underlying models to achieve desired performance goals.

The above-summarized technology can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative topic-processing system for identifying relevant topics in a set of documents.

FIG. 2 shows an example of the operation of the topic-processing system of FIG. 1.

FIG. 3 shows one implementation of a Named-Entity Recognition (NER) component, which is used in a first stage of processing performed by the topic-processing system of FIG. 1.

FIG. 4 shows one implementation of a processing block that can be used by the NER component of FIG. 3.

FIG. 5 shows one implementation of a topic-ranking component, which is used in a second stage of processing performed by the topic-processing system of FIG. 1.

FIG. 6 shows an optional two-phase approach that the topic-ranking component of FIG. 5 can use to rank topics.

FIG. 7 shows examples of post-processing components that can be used in the topic-processing system of FIG. 1. Each post-processing component performs some post-processing operation on a set of final topics identified by the topic-processing system.

FIG. 8 shows a production system that can use output results produced by the topic-processing system of FIG. 1.

FIG. 9 is a flowchart that provides an overview of one manner of operation of the topic-processing system of FIG. 1.

FIG. 10 is a flowchart that provides an overview of one manner of operation of the production system of FIG. 8.

FIG. 11 shows computing equipment that can be used to implement the systems shown in FIG. 1.

FIG. 12 shows an illustrative type of computing system that can be used to implement any aspect of the features shown in the foregoing drawings.

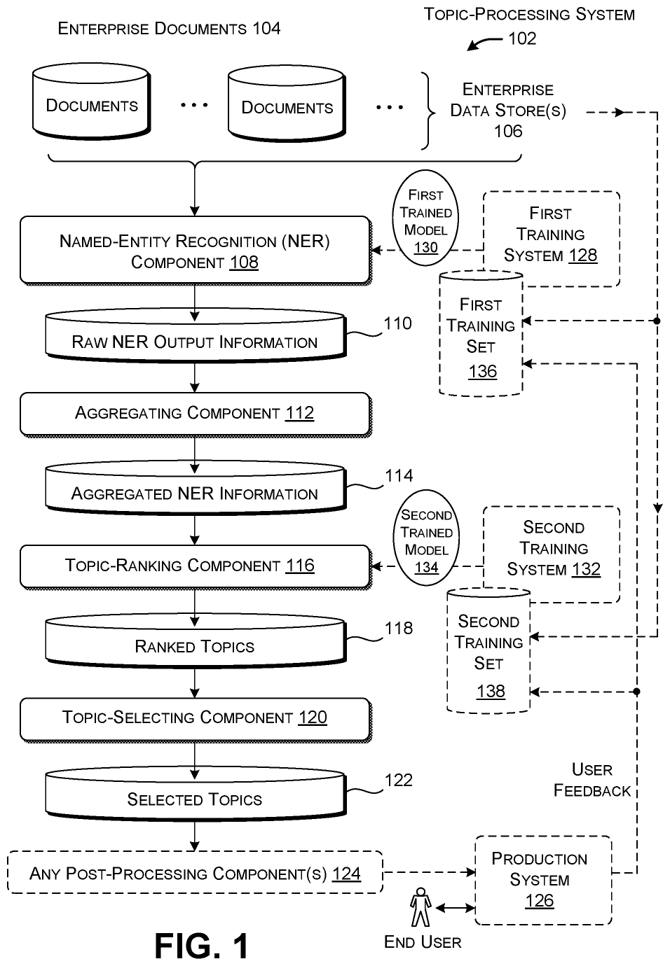

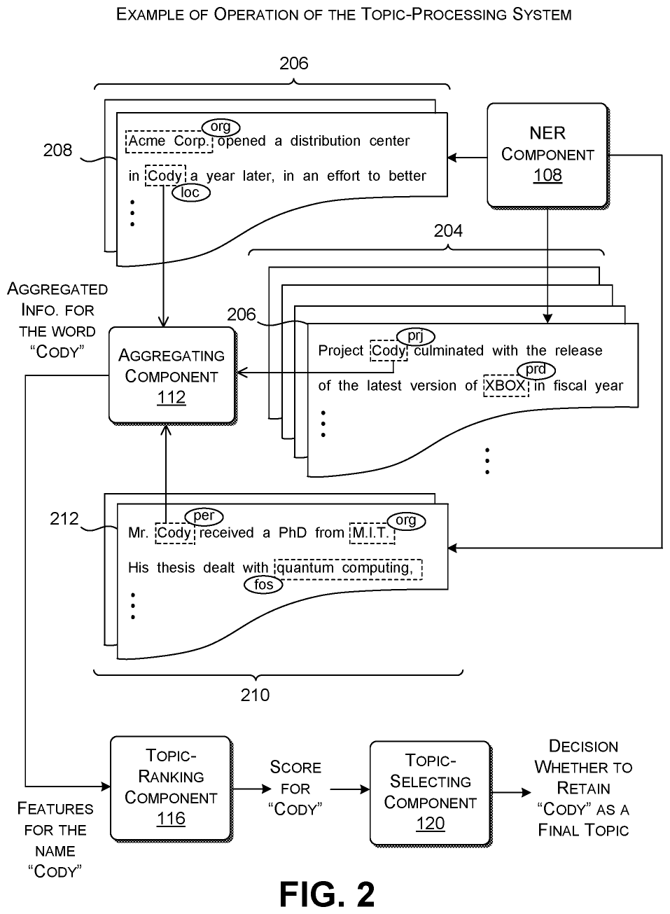

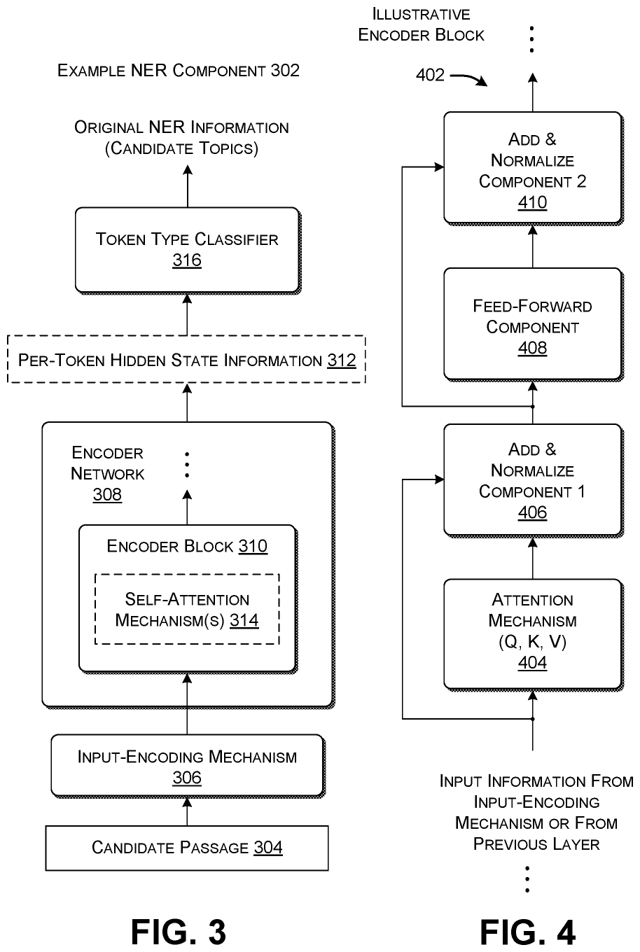

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a topic-processing system for identifying relevant topics in a set of documents. Section A also describes a production system for applying output results generated by the topic-processing system. Section B sets forth illustrative methods which explain the operation of the systems of Section A. And Section C describes illustrative computing functionality that can be used to implement any aspect of the features described in Sections A and B.

A. Illustrative Computing Systems

A.1. Overview of the Topic-Processing System

FIG. 1 shows an illustrative topic-processing system 102 for identifying relevant topics in a set of documents 104. In some implementations, an enterprise hosts the topic-processing system 102, and the documents refer to a collection of digital items maintained and used by the enterprise. The enterprise can correspond to any type of organization, such a company, a government, an educational institution, and so on. Without limitation, the documents can include any collection of digital items that include at least some text, including word processing application documents, spreadsheets, slide presentations, Portable Document Format (PDF) documents, Email messages, text messages, online articles, social network postings and messages, presentation transcripts, and so on. Some of the documents can use different types of structures to organize their information. This is true, for instance, with respect to forms. Other types of documents may represent unstructured resources. An enterprise stores its documents 104 in one or more data stores 106.

A “named entity” refers to a name of some identifiable thing, location, concept, or event, etc. mentioned in a document. The type of the named entity refers to its class or kind. Without limitation, representative types of named entities include:

“person,” “organization,” “place,” “event,” “project,” “field of study,” and so on. A “topic” refers to subject matter mentioned in a document. As used herein, a topic is considered synonymous with a named entity. For example, the name “Acme Corporation” that appears in a document refers to both a named entity having the type of “organization,” as a well as a particular topic.

Different enterprises will typically host different respective assortments of documents. Further, different enterprises will typically hosts documents relating to different distributions of topics. For example, a company that produces computer chips will typically produce and interact with documents that pertain to different topics than a company doing research in the field of biomedicine.

The purpose of topic-processing system 102 is to identify a collection of topics expressed by the documents 104 that will be most useful to members of an enterprise in performing their respective roles within the enterprise. The concept of “usefulness” is ultimately defined by the training examples used to produce the machine-trained classification model. That is, the training examples themselves identify what topics are considered as useful and what topics are considered not useful (or less useful than the useful topics). In many environments, members of a company will consider the names of current projects, employees, events, etc. as the most salient topics discussed within the company. The members will consider widely-used technical terms as being less relevant. Likewise, the members will likely consider former (or “old”) projects, employees, events, etc. as being less relevant.

By way of overview, the topic-processing system 102 performs its processing in two main stages. In the first stage, the topic-processing system 102 identifies a set candidate topics expressed by the documents 104. The second stage uses information imparted by the first stage to rank the candidate topics based on their presumed usefulness, to provide a set of ranked topics. The second stage may then choose a final set of topics from the set of ranked topics, e.g., by selecting a prescribed number of top-ranking topics, or by selecting any topic having a ranking score that is above a prescribed environment-specific threshold value.

More specifically, in the first stage, a Named-Entity Recognition (NER) component 108 processes each document in the set of documents 104 to identify named entities within that document. In some implementations, the NER component 108 performs its analysis by advancing through each document on a passage-by-passage basis. For example, the NER component 108 can identify the named entities within a document by performing analysis on successive sentences in the document, or successive paragraphs, etc. Alternatively, the NER component 108 can perform analysis by moving a window having a prescribed window size through the document. The NER component 108 can perform analysis on the words encompassed by the window at its present position, after which the window is slid to its next position (e.g., by advancing to the next word).

The NER component 108 can perform its analysis using different kinds of machine-learned models. Without limitation, for example, the NER component 108 can performs its analysis using a Conditional Random Fields (CRF) model, a Hidden Markov model (HMM), a Recurrent Neural Network (RNN), a transformer-based model, and so on. In general, the NER component 108 uses its machine trained model to determine, for each word it processes, whether that word is part of a named entity of a particular entity type, selected from a predetermined set of possible entity types. For example, the NER component 108 will determine whether a word under consideration is most likely part of an organization's name, or is most likely part of person's name, or is most likely part of a project's name, etc. Alternatively, the NER component 108 may determine that the word does not match any entity type with a sufficiently high degree of confidence, upon which the NER component 108 will conclude that the word is not part of any entity name.

The NER component 108 will make its determination for each particular word based on other words in the passage under consideration that includes the particular word. For instance, the NER component 108 can make its determination for a word in a sentence based on all of the words in the sentence. In any event, the NER component 108 makes it determination based on relatively narrow focus of consideration, defined by a relatively small collection of neighboring words within the document under consideration.

The NER component 108 stores original NER information in a data store 110. The original NER information identifies all of the named entities discovered in the set of documents 104. The named entities also correspond to an initial set of candidate topics. As mentioned above, for example, if the organization name “Acme Corporation” appears in a document, that name is both a named entity and a candidate topic.

As noted above, a candidate topic may or may not be a useful topic to members of an enterprise. For instance, presume that the NER component 108 identifies the name “back propagation” as a candidate topic, e.g., having an entity type of “field of study.” This term is widely used in the field of artificial intelligence. Even if the enterprise is a software company that produces products in the field of artificial intelligence, it is unlikely that the members of the organization will consider the term “back propagation” a useful topic in performing their work. The second stage of the topic-processing system 102 performs the task of discriminating between useful and less-useful topics. To repeat, the terms “useful” and “not useful” are ultimately defined by the training examples, which identify instances of useful and not useful topics.

The topic-processing system 102 commences its second-stage analysis by using an aggregating component 112 to generate plural features for each candidate topic identified by the NER component 108. The aggregating component 112 generates at least some of its features for a particular candidate topic based on a consideration of how this topic is used across the set of documents 104 (or some subset thereof). For example, for the representative candidate topic XBOX, the aggregating component 112 generates at least one feature that describes the most common entity type that has been associated with the name XBOX across the documents 104. Additional information regarding the operation of the aggregating component 112 will be set forth below, along with a representative set of features that it can produce for each candidate topic. The aggregating component 112 stores its output results in a data store 114. The output results are collectively referred to herein as “aggregated information.” The aggregated information includes a set of features for each candidate topic.

A topic-ranking component 116 uses a machine-trained classification model to assess the usefulness of each candidate topic based on the aggregated information produced by the aggregating component 112. Without limitation, for instance, the topic-ranking component 116 can perform this task using a logistic regression model, a boosted-gradient decision tree model, a random forest model, a neural network model of any type(s) (such as a transformer-based classification model), and so on. More specifically, the topic-ranking component 116 performs its task for each candidate topic by mapping the features associated with the candidate topic to a ranking score, ranging from 0 to 1. The ranking score describes the assessed usefulness of the candidate topic. Generally, the scored candidate topics constitute a set of ranked topics. The topic-ranking component 116 stores information regarding the ranked topics in a data store 118.

A topic-selecting component 120 selects a subset of the ranked topics based on their respective ranking scores, to produce a final set of topics. In most implementations, the final set of topics can be expected to include fewer topics than the initial set of candidate topics. As mentioned above, in some implementations, the topic-selecting component 120 performs its task by selecting an environment-specific prescribed number of top-ranking topics. Alternatively, the topic-selecting component 120 chooses all candidate topics that have ranking scores above a prescribed environment-specific threshold value. The topic-selecting component 120 stores information regarding the set of final topics in a data store 122.

One or more post-processing components 124 can perform one or more respective post-processing operations that depend on the final set of topics produced by the topic-processing system 102. Representative post-processing component 124 will be described in greater detail below. By way of preview to that later description, one general class of post-processing components links a final topic to supplemental information regarding that final topic. For example, one kind of post-processing component generates a topic page associated with a particular final topic. The post-processing component then generates a digital link that connects the final topic to the generated topic page.

A production system 126 refers to any computing system that uses the results generated by the topic-processing system 102. Representative production systems will be described in greater detail below. By way of preview to that later description, one production system uses a document viewer that allows an end user to interact with any document. The production system can highlight the names in the documents that correspond to final topics identified by the topic-processing system 102. The production system can also allow a user to select any highlighted name (e.g., by hovering above it), upon which the production system displays or otherwise presents a topic page that pertains to the highlighted name. To perform this task, the production system will activate a link previously created by a post-processing component.

Finally, FIG. 1 shows a first training system 128 that is used to produce a first machine-trained model (e.g., a NER model) 130 that governs the operation of the NER component 108, and a second training system 132 that is used to produce a second machine-trained model (e.g., a classification model) 134 that governs the operation of the topic-ranking component 116. Additional details regarding the training systems (128, 132) will be set forth below. Generally, in some implementations, the first training system 128 produces its machine-trained NER model by iteratively operating on a set of training examples in a data store 136, while the second training system 132 independently produces its machine-trained classification model 134 based a set of training examples in a data store 138. More generally, a machine-trained model is defined by set of weights produced by a training system, combined with logic that implements a particular model architecture.

According to one technical benefit, the topic-processing system 102 provides a technique for increasing the relevance of topics presented to users in a production system. Stated in the negative, the topic-processing system 102 functions as a filter which reduces the amount of low-relevance noisy topics that are presented to the user. The topic-processing system 102 performs this task by extracting insight from the distribution of the original NER information across the entire set of documents.

The topic-processing system 102 also reduces the amount of system resources that are required to process the final topics (relative to the original number of candidate topics). This is because the final set of topics is smaller than the original set of candidate topics, and it requires fewer resources to process a smaller set of topics compared to a larger set of topics. For instance, the topic-processing system 102 reduces the number of topic pages that need to be generated for the identified topics, and reduces the system resources that are required to present the topic pages to users. System resources include memory resources, storage resources, processing resources, communication resources, etc.

The production system 126 can also reduce the number of annotations that it presents associated with identified topics, again by virtue of the fact that the topic-processing system 102 winnows the initial set of candidate topics to a smaller set of final topics. This system behavior assists the user in interacting with a document, e.g., by not overwhelming the user with a large number of low-value annotations. The topic-processing system 102 also reduces the amount of system resources that are necessary to produce the annotations and to process the user's interaction with the annotations.

According to another technical benefit, the topic-processing system 102 provides a general-purpose and scalable way of gauging the importance of topics within many different types of enterprises. This general-purpose characteristic ensues from the two-stage nature of its processing, and particularly the way it leverages aggregated information produced by the aggregating component 112. This characteristic, in turn, facilities the task of developing machine-trained models for different enterprises and their respective sets of documents. The topic-processing system 102 also provides a resilient technique for addressing changes in the kinds and themes of documents provided by an enterprise. Further still, the topic-processing system 102 provides an extensible framework for expanding its machine-trained classification model 134. For example, the topic-processing system 102 can accommodate a developer who wishes to add one or more new statistical features that it uses to assess the importance of topics. A developer can retrain the machine-trained classification model 134 based on the new feature set, without modifying the overall architecture of the topic-processing system 102.

To illustrate the above-noted technical advantages, consider an alternative strategy that attempts to model the structure of documents in the enterprise, and then attempts to extract information items from predefined fields within the documents. This tactic is problematic because it presupposes advance knowledge of the kinds of documents used by an enterprise and their respective structures, which is information that is often not available to the developer. Further, the heuristic rules and handcrafted features developed for one enterprise are generally not applicable to other enterprises. By contrast, the topic-processing system 102 produces a solution that applies to many different types of enterprises. As such, the topic-processing system 102 eliminates or reduces the resource-intensive and time-intensive practice of manually developing a set of ad hoc features and/or heuristic rules to describe the unique characteristics of an enterprise's documents. Further, the topic-processing system 102 makes no assumptions and imposes no constraints regarding the respective structures of the documents maintained by an enterprise.

According to yet another technical benefit, the training systems (128, 132) can quickly produce their machine-trained models in a resource-efficient manner. This advantage is again best explained relative to an alternative strategy, such as a strategy that involves identifying topics using a conventional single-stage NER machine-trained model. It may be possible for a developer to train this conventional model to eventually achieve a desired performance goal. But the training systems (128, 132) shown in FIG. 1 can produce acceptable performance goals more quickly, and with a smaller data set, compared to the above-described single-stage alternative technique. This superior performance ensues from the fact that the topic-processing system 102 can better determine the importance of topics compared to the single-stage conventional model. Finally, by more quickly achieving desired performance goals, the training systems (128, 132) can consume fewer system resources compared to alternative techniques.

The above-described technical characteristics are set forth in the spirit of illustration, not limitation. Other implementations of the topic-processing system 102 can exhibit additional characteristics that can be considered advantageous.

Other implementations of the topic-processing system 102 can add one or more components to the architecture shown in FIG. 1, and/or can remove one or more components from the architecture shown in FIG. 1. For example, other implementations of the topic-processing system 102 can include a synonym-detecting component (not shown) which merges groups of final topics that are considered synonymous into representative topic names for those groups.

FIG. 2 shows a simplified example of the operation of the topic-processing system 102 with respect to a single candidate topic. The NER component 108 processes a particular set of documents, a small subset of which is shown in FIG. 2. A first subset of documents 202 contain text that mentions the named entity “Cody” in a first context to describe a particular project within the enterprise. That is, each named entity in the first subset of documents 202 has the entity type of “project.” Document 204 is a representative member of the first subset of documents 202. More generally, FIG. 2 annotates identified named entities in the representative document 204 with information that describes their respective entity types, e.g., by annotating the name “Cody” with “prj” to indicate that it corresponds to an entity type of “project.”

A second subset of documents 206 contain text that mentions the named entity “Cody” in a second context to describe the name of a particular place (e.g., the name of a city in the U.S. State of Wyoming). That is, each named entity in the second subset of documents 206 has the entity type of “location.” Document 208 is a representative member of the second subset of documents 206.

A third subset of documents 210 contain text that mentions the named entity “Cody” in a third context to describe the name of at least one particular person. That is, each named entity in the third subset of documents 210 has the entity type of “person.” Document 212 is a representative member of the third subset of documents 210. This scenario is merely representative. In other examples, a given name may map to more entity types or less entity types compared to the name “Cody” shown in FIG. 2.

The aggregating component 112 generates a set of features that summarize the occurrence of the candidate topic “Cody” across all of the documents. The topic-ranking component 116 maps the features associated with “Cody” to a ranking score. The topic-selecting component 120 determines whether it is appropriate to include “Cody” as a final topic based on its ranking score. Assume that the topic-selecting component 120 determines that the topic “Cody” is an appropriate final topic, e.g., because its ranking score exceeds a prescribed environment-specific threshold.

In some cases, a post-processing component can create a topic page for the name “Cody” to reflect its most common usage. For example, assume that the great majority of documents use the word “Cody” to refer to a particular project within the enterprise. If so, the post-processing component can create a topic page for the Cody project, and then link the project name “Cody” to the generated topic page for project “Cody.” In some implementations, the post-processing component will not prepare topic pages for other respective uses of the word Cody (such as “Cody” as a place, or “Cody” as a person). Similarly, the production system 126 will not highlight any other usages of the word “Cody” in the text documents. But in other implementations, the post-processing component can generate different topic pages for different respective usages of the word “Cody,” if those usages meet prescribed conditions. Subsequently, the production system 126 will highlight all occurrences of the word “Cody” for which linked topic pages exist. The production system 126 will allow the user to access a type-specific topic page when the user selects a particular instance of the word “Cody” having a particular entity type.

Different implementations of the topic-processing system 102 can vary the above behavior in different respective ways. In some implementations, the topic-processing system 102 will identify different capitalizations of the word “Cody” as potentially referring to different named entities, e.g., by treating “Cody” as a first name and “CODY” as a second name. In other implementations, the topic-processing system 102 will ignore capitalization, font, etc. in determining whether two occurrences of the word “Cody” are to be considered the same name.

A.2. Representative Aggregated Information

Different implementations of the aggregating component 112 can generate different respective sets of features for each candidate topic. The following provides a non-limiting description of a set of features that one implementation of the aggregating component 112 can generate for a candidate topic, such as the name “Cody” discussed above which appears in different contexts across the documents 104.

A first feature (CharUpperCasePercentage) refers to a percentage of uppercase characters in a candidate topic under consideration. For example, all occurrences of the name “Cody” have one uppercase character. An occurrence of the name “CODY” (not shown) would have four uppercase characters. In some implementations, the aggregating component 112 operates on the principle that all names associated with a candidate topic have the same capitalization scheme. In other implementations, the aggregating component 112 can allow names associated with the candidate topic to have different capitalization schemes; in those implementations, the aggregating component 112 can generate the first feature as a summary (e.g., as an average) of the number of uppercase letters in the candidate topic, measured across the set of documents.

A second feature (NumTypeString) refers to a number of entity types that the NER component 108 has detected for the candidate topic. For example, in the example of FIG. 2, the NER component 108 has detected three different kinds of entity types. Thus, in that case, the second feature has a value of 3.

A third feature (MaxTypeCount) describes the number of times a most-prevalent entity type appears within the set of documents, for the candidate topic under consideration. For example, assume that the entity type “project” is most prevalent for the word “Cody.” In that case, the third feature would have a value equal to the number of times that that the word “Cody,” when identified as a project, occurs across the entire set of documents. Although not shown in FIG. 2, a single document can include two or more occurrences of the word “Cody,” and the third feature will take into account each separate occurrence.

A fourth feature (YuNerFrequency) describes the total number of times a candidate topic occurs within a set of documents, regardless of entity type. For example, the fourth feature would correspond to the number of occurrences of the name “Cody” when classified as a project, together with the number of occurrences of the name “Cody” when classified as a place, together with the number occurrences of the name “Cody” when classified as a person. Again, the word “Cody” may occur plural times within any document, and the fourth feature takes account for these distinct occurrences.

A fifth feature (YuNerDocFrequency) describes a number of documents that include the detected candidate topic. In the example of FIG. 2, the fifth feature would have a value that is equal to the number of documents that include the name “Cody” regardless of entity type.

A sixth feature (TopicDocFrequencyRatio) describes a ratio of the fifth feature (YuNerDocFrequency) to the fourth feature (YuNerFrequency).

A seventh feature (MaxTypeRatio) describes a ratio of the third feature (MaxTypeCount) to the fourth feature (YuNearFrequency).

An eighth feature (TopicTitleCount) refers to a number of times the candidate name appears in a document title within a set of documents.

A ninth feature (TopicLength) describes a number of characters in the candidate name. The name “Cody” would have a length of four characters. In some implementations, the assumption is that all occurrences of the same candidate topic have the same length. In other implementations, the aggregating component 112 can treat different lexical variations of a candidate topic as referring to the same candidate topic. In those implementations, the aggregating component 112 can compute the ninth feature as an average of the character lengths across the different variations.

A tenth feature (NumTokensOfTopicName) refers to the number of tokens in a candidate topic. In some implementations, the number of tokens refers to the number of distinct words in the candidate name. For example, the tenth feature would have a value of 1 for the name “Cody.” In other implementations, a token can refer to a fragment of a word, such as an n-gram. Again, some implementations can make the assumption that all occurrences of the same candidate topic have the same number of tokens, while other implementations can allow some variation in the number of tokens across occurrences of what is considered to be the same candidate name.

An eleventh feature (FirstCharUpperCase) is a binary-valued feature that indicates whether the first character of the candidate topic is an uppercase character.

A twelfth feature (ViewCount) describes the number of times users have previously accessed documents that contain the candidate topic under consideration. For example, the twelfth feature describes a number of times that users have opened documents in a shared store and/or local data stores, where those documents include at least one occurrence of the candidate topic under consideration.

A thirteenth feature (ModificationTimeTotal) is a summation of the ages of the documents that include a candidate topic under consideration. The “age” of a document refers to the time at which it was last modified, and can be expressed as an absolute time or a relative time (that is, by indicating when the document was last modified relative to the current time).

A fourteenth feature (ModificationTimeSquared) can represent the square of the thirteenth feature.

A fifteenth feature (AverageModificationTime) represents an average of the ages of the documents that contain a candidate topic under consideration. Again, an “age” of a document may refer to the time at which the document was last modified, expressed in absolute or relative terms. The thirteenth through fifteenth features generally attempt to gauge the extent to which the candidate topic under consideration is a presently-trending name. The aggregating component 112 can use these kinds of features to discount the relevance of stale topics that are no longer attracting significant attention within an enterprise.

A sixteenth feature (EntityType) identifies whether the most prevalent usage of the candidate topic corresponds to one of a set of favored entity types (e.g., product, organization, project, etc.), rather than some other type of entity type.

To repeat, the above set of features is set forth here in the spirit of illustration, not limitation. Other implementations can include additional features not described above, and/or can omit any of the features described above.

The aggregating component 112 can normalize at least some of the above-described features. The aggregating component 112 can normalize a feature using one or more normalization techniques, such as logarithmic transformation, min-max normalization, etc. More specifically, in some implementations, the aggregating component 112 can compute the log of any frequency-based feature, such as the fifth feature (YuNerDocFrequency) that describes a number of documents that include the detected candidate topic. This conversion helps mitigate the impact of outlying feature values. In addition, the aggregating component can perform min-max normalization for all features. Min-max normalization involves: (1) identifying the minimum and maximum feature values across a collection of documents for a particular feature under consideration; (2) subtracting the minimum value from the maximum value to produce a difference; and (3) dividing each feature value by the difference. In some implementations, the aggregating component 112 computes the difference in step (2) based on a prescribed number of top-ranked topics (e.g., the top 75,000 ranked topics), rather than the complete set of ranked topics.

A.3. Illustrative NER Component

FIG. 3 shows one non-limiting implementation of a Named-Entity Recognition (NER) component 302, corresponding to a particular instantiation of the NER component 108 described above and shown in FIG. 1. The NER component 302 identifies named entities and their respective entity types in documents. The particular NER component 302 shown in FIG. 3 uses a transformer-based neural network to perform this task. Other implementations can use other kinds of models, such as a CRF model, an RNN model, an HMM model, etc., or any combination thereof.

In some implementations, the NER component 302 receives input information in the form of an input passage 304 within a document. For example, the input passage 304 may correspond to an individual sentence in the document, an individual paragraph, a window of n consecutive words (which need not correspond to a single sentence or paragraph), etc. In any event, the input passage 304 includes plural tokens. The tokens correspond to parts of the input passage 304, such as individual words, n-grams, etc.

An input-encoding mechanism 306 converts the tokens in the input passage 304 to input vectors. For example, the input-encoding mechanism 306 can use a lookup table, a neural network, or a hashing function to convert each token into an input vector of a prescribed dimension. Each input vector includes a distribution of values that describe its corresponding token within a semantic space. The input-encoding mechanism 306 can also add position information to each input vector which describes the position of the corresponding token within the sequence of tokens that make up the input passage 304.

An encoder network 308 uses one or more encoder blocks (such as representative encoder block 310) to convert the input vectors into hidden state information 312. Each encoder block 310 includes at least one attention mechanism, such as a representative self-attention mechanism 314. Additional detail regarding the operation of each attention mechanism is provided below. In general, when interpreting a particular token in the input passage 304, the attention mechanism determines an extent of influence that each other token in the input passage 304 has on the particular token. The hidden state information 312 includes counterpart output vectors associated with the tokens in the input passage 304.

A token-type classifier 316 maps each output vector to probability information. The probability information describes, for each of a plurality of possible entity types, the likelihood that the token under consideration corresponds to that entity type (if any). Alternatively, the token-type classifier 316 will conclude that the token under consideration does not correspond to any named entity if none of the entity types is detected with a prescribed degree of confidence. The token-type classifier 316 can be implemented as a neural network of any type followed by logic that performs a Softmax operation (that is, a normalized exponential function).

FIG. 4 shows one implementation of a representative encoder block 402, e.g., which can be used to implement the encoder block 310 of FIG. 3. The encoder block 402 is implemented as a multi-layer transformer-based neural network that includes an attention mechanism 404. The encoder network 308 (of FIG. 3) may include a pipeline of the kind of processing blocks shown in FIG. 4, with the output of one processing block serving as input information to a subsequent processing block.

In some non-limiting implementations, the processing block 402 includes the attention mechanism 404, an add-&-normalize component 406, a feed-forward component 408, and another add-&-normalize component 410. The attention mechanism 404 performs attention (e.g., self-attention, etc.) in any manner, such as by using the transformations described below. The first add-&-normalize component 406 adds the input information fed to the attention mechanism 404 to the output information provided by the attention mechanism 404 (thus forming a residual connection), and then performs layer-normalization on that result. Layer normalization entails adjusting values in a layer based on the mean and deviation of those values in the layer. The feed-forward component 408 uses one or more fully connected neural network layers to map input information to output information. The second add-&-normalize component 410 performs the same function as the first add-&-normalize component 406.

In some implementation, the attention mechanism 404 generates attention information using the following equation:

$$attn ( Q , K , V ) = softmax ( \frac{Q {K}^{T}}{\sqrt{d}} ) V . \qquad ( 1 )$$

Query information Q is produced by multiplying the input vectors associated with the input passage 304 by a query weighting matrix W^{Q}. Key information K and value information V are produced by multiplying the same input vectors by a key weighting matrix W^{K} and a value weighting matrix W^{V}, respectively. Equation (1) involves taking the dot product of Q by the transpose of K, and then dividing that dot product by a scaling factor V, where \sqrt{d} may represent the dimensionality of the machine-learned model. This yields a scaled result. Equation (1) then involves computing the Softmax of the scaled result, and then multiplying the result of the Softmax operation by V.

Each subsequent encoder block in the encoder network 308 operates in the same manner as the first encoder block 310. However, each subsequent encoder block builds the query information Q, key information K, and value information V based on the output of a preceding encoder block.

A.4. Illustrative Topic-Ranking Component

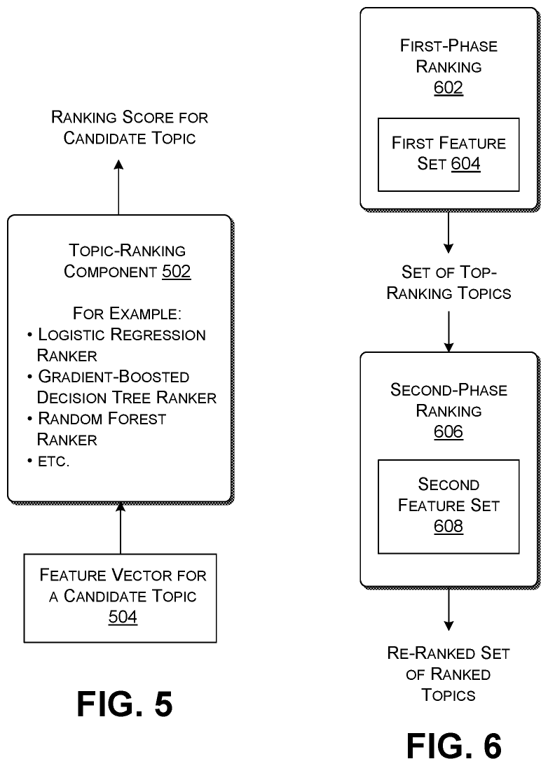

FIG. 5 shows one implementation of a topic-ranking component 502. As noted above, the topic-ranking component 502 can apply any type of machine-trained model, such as a logistic regression model, a gradient-boosted decision tree model, a random forests model, etc., or any combination thereof. Generally, the topic-ranking component 502 operates by mapping a feature vector 504 that encodes the features associated with each candidate topic to a ranking score. The ranking score describes the suitability of the candidate topic for inclusion in the set of final topics. For example, in the case of a logistic regression model, the topic-ranking component 502 can generate the ranking score as a weighted sum of the different features expressed by the feature vector 504. The second training system 132 (of FIG. 1) generates the weights used in the weighted sum.

Different models have respective advantages. For example, a gradient-boosted decision tree model is particularly resilient to deficiencies in the training set. The use of this model therefore offers good performance for topics that are not adequately exhibited in the training set.

FIG. 6 shows an optional two-phase process for ranking candidate topics using the topic-ranking component 502. In the first phase 602, the topic-ranking component 502 can apply a first set of features 604 to rank the documents. In a second phase 606, the topic-ranking component 502 can select a prescribed number of topic-ranking topics produced by the first phase 602, such as a set of 75,000 topics. The topic-ranking component 502 then uses a second set of features 608 to refine the ranking of the topics in the initial set of topics.

In some implementations, the second set of features 608 is more descriptive than the first set of features 604, and imposes more constraints compared to the first set of features 604. For example, in the first phase 602, the topic-ranking component 502 can rank the topics based on just their frequency-of-occurrence over the complete set of documents 104 in the enterprise. In the second phase 606, the topic-ranking component 502 can re-rank the top-ranking set of topics produced by the first phase 602 using the more expansive set of features described in Subsection A.2 above, e.g., by using the first through eighth features described therein. By virtue of this approach, the topic-ranking component 502 can expedite its processing of topics and consume a reduced amount of system resources (compared to the strategy of using a single robust set of features to rank all of the documents 104 in a single stage). In one implementation, the second phase 606 performs min-max normalization (described earlier) for each feature based on the maximum and minimum values for this feature extracted from the first phase 602.

Consider the following example of the operation of the two-phase approach shown in FIG. 1. The first phase 602 may give a relatively high rank to a topic (such as “graphics processing unit”) because it appears many times in the set of documents. But this topic may not be very useful to users of the enterprise because it is a widely used term without much specific relevance to specific teams and projects within the organization. The second phase 606 will therefore likely lower the ranking the topic. The contrary case is likewise true. The first phase 602 may give a topic a relatively low score because it is not widely found in the documents. But the topic may nevertheless serve as a useful term to describe current activities within the enterprise. Accordingly, the second phase 606 can increase the position of this term in the ranking. At the same time, the first phase 602 will prevent very rare topics from being included in the set of final topics.

A.5. Illustrative Post-Processing Components

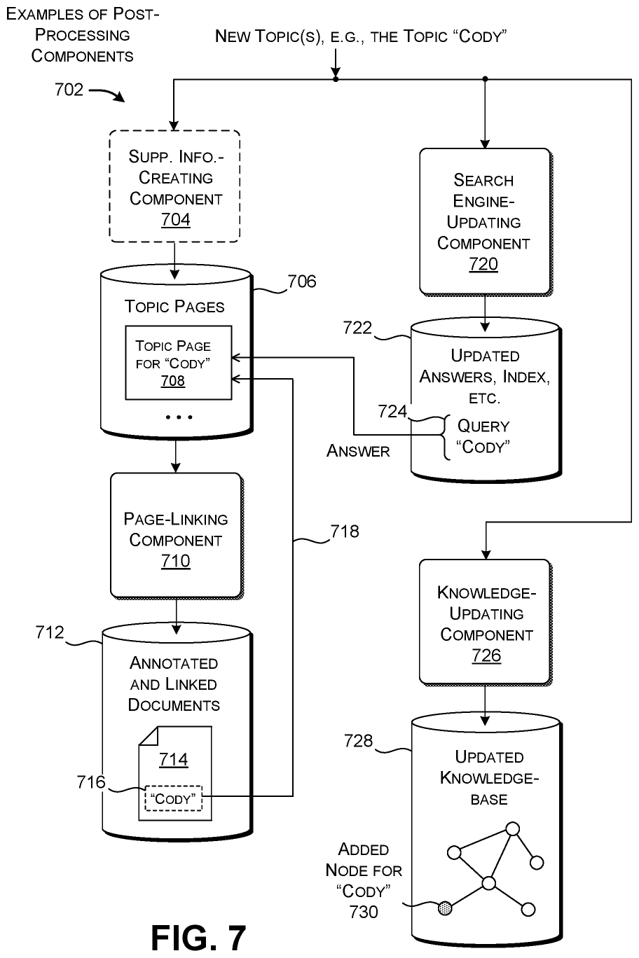

FIG. 7 shows examples of post-processing components 702 that can be used in the topic-processing system 102 of FIG. 1. Each post-processing component performs some post-processing operation on a set of final topics identified by the topic-processing system 102.

A first post-processing component generates one or instances of supplemental information for each identified final topic (such as the topic of “Cody”). It then links each final topic to a generated instance of supplemental information. To facilitate explanation, an instance of supplemental information is referred to as a “topic page.” In some implementation, a topic page can include various fields of information regarding a topic, such as any of: 1) a definition of the topic; 2) at least one image associated with the topic; 3) people associated with the topic; and/or 4) resources associated with the topic (such as specification documents, etc.), and so on. Further, the topic page can include any combination of media types, such as text, graphics, image, audio, video, etc. More generally, an instance of supplemental information can include any fields of information, any combination of media types, and any number of parts (e.g., any number of pages).

As a first step, a supplemental information-creating component (“creating component” for brevity) 704 generates at least one topic page for a final topic. In some implementations, the creating component 704 corresponds to an application that allows a user to manually create the page, e.g., by manually creating a textual description of the final topic. Alternatively, or in addition, the creating component 704 automatically identifies one or more online resources that are relevant to the final topic, and mines the resource(s) for topic information. For example, the creating component 704 can identify a Wikipedia page that is relevant to the final topic. Alternatively, or in addition, the creating component 704 includes a generative machine-trained model or other kind of model that automatically generates at least parts the topic page based on reference sources pertaining to the topic. The creating component 704 stores the topic pages that it creates in a data store 706. FIG. 7 shows a representative topic page 708 for the topic “Cody.”

A page-linking component 710 creates a digital link between final topics and topic pages associated with the final topic. The digital link can take any form, such as a pointer, a Uniform Resource Locator (URL), etc. FIG. 7 summarizes the above manner of operation by showing a data store 712 that stores a representative document 714 having an instance 716 of the final topic (e.g., an instance of the name “Cody”). The page-linking component 710 creates a digital link 718 that will connect the instance 716 of the name “Cody” to the topic page 708 for the topic “Cody.”

In some implementations, the page-linking component 710 can produce a lookup table that maps final topics to respective topic pages. A production system can rely on the lookup table to access an appropriate topic page when a user selects an expression of a final topic in a document. In other words, in these implementations, the page-linking component 710 does not actually modify a document to include the digital link; rather, the lookup table that includes the digital link exists apart from the document. In other implementations, the page-linking component 710 can actually modify a document to include a link to an associated topic page. Still other linking strategies are possible.

A search engine-updating component 720 is part of a second post-processing component. The search engine-updating component 720 updates a data store 722 that is used by a search engine (not shown) to perform a search. For example, the search engine-updating component 720 updates the data store 722 such that, when a user performs a search that is relevant to the topic “Cody,” the search engine will provide appropriate information regarding the topic of “Cody.”

The search engine-updating component 720 can perform its updating operation in different ways. In some implementations, the search engine-updating component 720 can create an entry in the data store 722 that links a final topic (“Cody”) or the question (“What is Cody,”) to a pre-generated answer regarding the topic of “Cody” (such as the representative answer, “Cody is a FY2021 project that introduces new artificial intelligence features to XBOX”). In an application phase, the search engine will use a query including the name “Cody” as a lookup key to retrieve the pre-generated answer pertaining to the topic of “Cody.” In other implementations, the search engine-updating component 720 can include an entry 724 that maps the topic “Cody” to a URL associated with the topic page 708 for “Cody.”

A knowledge-updating component 726 is part of a third post-processing component. The knowledge-updating component 726 updates a knowledge base in a data store 728 in response to the discovery of a new final topic. For instance, assume that the knowledge base takes the form of a graph of nodes, where each node corresponds to a final topic. The knowledge-updating component 726 can create a new node 730 for the newly-discovered topic of “Cody” and link that node 730 to related topic nodes in the graph. In some implementations, the knowledge-updating component 726 corresponds to an application that allows a user to manually update the graph. Alternatively, or in addition, the knowledge-updating component 726 can automatically create the node 730 for the topic of “Cody.” For instance, the knowledge-updating component 726 can observe that a relatively large number of documents include the name “Cody” in close proximity to the name “XBOX.” Based on this finding, the knowledge-updating component 726 can automatically link the node 730 for “Cody” to the preexisting node for the topic of XBOX.

In summary, the three types of post-processing components described above link an expression of a final topic with supplemental information regarding the final topic. The first post-processing component links a name that appears in a document with a topic page. The second post-processing component links a query relating to a final topic with a pre-generated answer regarding to the topic, or to a topic page regarding the topic, etc. The third post-processing component links a knowledge graph node associated with a final topic to at least one other knowledge graph node. These types of post-processing components are presented in the spirit of illustration, not limitation.

A.6. Illustrative Production System

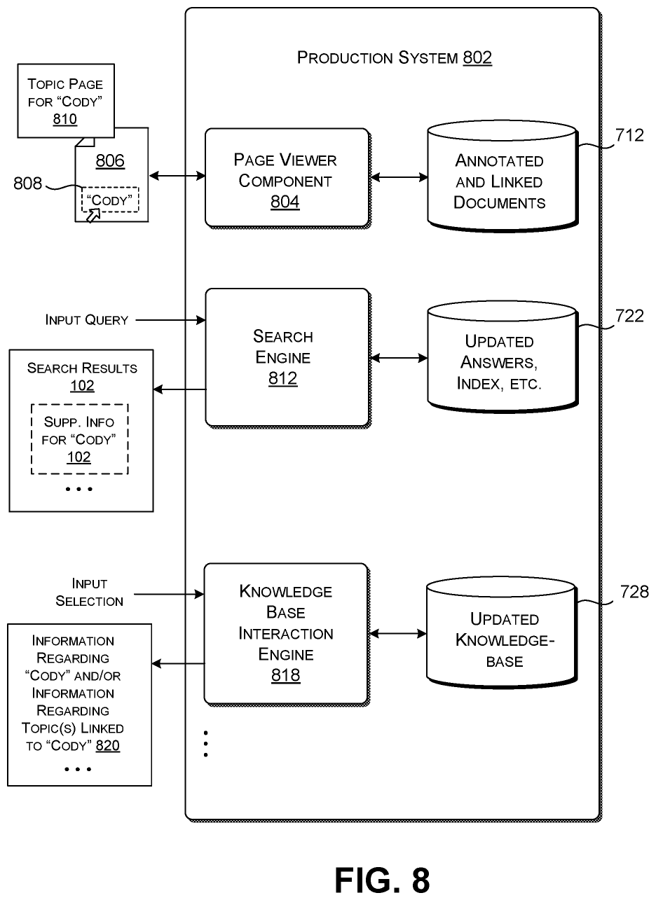

FIG. 8 shows an illustrative production system 802 that can use output results produced by the topic-processing system 102 of FIG. 1. Generally, the production system 802 includes functionality that utilizes and complements the updated information produced by the post-processing components described in Subsection A.5.

More specifically, a page viewer component 804 allows a user to open and view a document 806 that includes identified topics, such as the name “Cody” 808. The page viewer component 804 can highlight the identified topics in any graphical manner. Further, upon detecting that the user has selected an identified topic within the document 806, the page viewer component 804 can present a topic page associated with that topic. More specifically, the page viewer component 804 can detect that the user is hovering above an identified topic in the document with a mouse pointer, a finger, etc., or that the user has more explicitly selected the identified topic (e.g., by clicking on it). In response, the page viewer component 804 can access a digital link associated with the identified topic. The digital link may be an entry of a lookup table or may be part of the document 806 itself, etc. The page viewer component 804 can then use the digital link to retrieve whatever topic page or other supplemental information is specified by the digital link. The page viewer component 804 then displays the topic page 810 in proximity to the word “Cody” 808 in the document 806.

A search engine 812 detects that the user has submitted an input query that includes an identified topic, such as a query that contains the name “Cody” or that otherwise is related to the name “Cody.” The search engine 812 can reach this conclusion based on any kind of lexical processing (e.g., edit distance processing) and/or semantic processing (e.g., cosine similarity comparison of semantic vectors), etc. In response, the search engine 812 accesses a digital link associated with “Cody,” and uses that link to access a pre-generated answer relating to the topic “Cody,” or uses the link to access other information regarding the topic “Cody.” The search engine 812 then delivers search results 814 that include an entry 816 that provides the identified answer or other information regarding the identified name (such as by providing a URL link to a topic page associated with the identified name).

A knowledge base interaction engine 818 provides an application that allows a user to interact with the updated knowledge base in the data store 728. For instance, the knowledge base interaction engine 818 can detect when a user selects a node in a knowledge graph associated with a final topic. In response, the knowledge base interaction engine 818 can identify information 820 regarding the final topic, and/or can provide information 820 regarding one or topics that are linked to the final topic by the knowledge graph, and/or can provide supplemental information regarding the final topic and/or linked topics.

A production system can incorporate yet other functionality that leverages the final topics produced by the topic-processing system 102 of FIG. 1. The above-described functionality is presented in the spirit of illustration, not limitation.

A.7. Training Systems

To repeat a point made in Subsection A.1, the first training system 128 produces a first machine-trained model (e.g., an NER model) 130 that governs the operation of the NER component 108 based on a set of training examples in a data store 136, while the second training system 132 produces a second machine-trained model (e.g., a classification model) 134 that governs the operation of the topic-ranking component 116 based on a set of training examples in a data store 138. In some implementations, the first training system 128 and the second training system 132 can produce their respective machine-trained models in independent fashion based on different training sets. In other implementations, the first training system 128 and the second training system 132 can work together in producing their machine-trained models. Further, in some implementations, the first and second training sets can overlap in whole or part.

The first training set that is used to produce the first machine-trained model 130 includes a set of textual passages having labeled entity types. For example, a passage in the first training set can include a sentence with the word “Cody” in it, with that word annotated to reflect its designated entity type. Users can manually create these labeled textual passages. In addition, or alternatively, the first training system 128 can mine the textual passages from any text source(s) having labeled entity names. The first training system 128 iteratively produces the first machine-trained model 130 by successively increasing the accuracy at which the first machine-trained model 130 correctly predicts entity types in training examples. The first training system 128 can perform this task using any training technique, such as back propagation and stochastic gradient descent, etc.

The second training set that is used to produce the second machine-trained model 134 includes a set of topics with scores that correctly designate the respective usefulness of the topics to an enterprise. For example, a training example in the second training set can include the topic “Cody” along with a score that indicates the extent to which this topic serves as a useful category for the enterprise. Users can manually create these scored topics. In addition, or alternatively, the second training system 132 can mine the scored topics from any source(s) that explicitly include such information (such as existing knowledge sources having scored categories), and/or any source(s) from which the usefulness of identified topics can be implied based on various contextual signals. The second training system 132 iteratively produces the second machine-trained model 134 by successively increasing the accuracy at which the second machine-trained model 134 correctly predicts the usefulness of topics. The second training system 132 can perform this task using any training technique, such as back propagation and stochastic gradient descent, etc.

FIG. 1 shows dashed lines that indicate the illustrative flow of information to the first and second training sets in the data stores (136, 138). FIG. 1 also shows dashed lines that indicate the flow of information from the production system 126 to the first and second training sets in the data stores (136, 138). The flow from the production system 126 may specifically indicate feedback from users, which indicates whether they approve or disapprove of the results produced by the topic-processing system 102. For example, the feedback may indicate that some users have rejecting a final topic, and/or that some users have manually added a new topic that is not encompassed by the set of final topics produced by the topic-processing system 102. These flow lines generally indicate that the topic-processing system 102 can evolve to automatically take into account for the use of new kinds of documents in an enterprise, new themes discussed in these documents, and new assessments of the themes within the organization. Such behavior allows the topic-processing system 102 to automatically evolve to account for changes within the enterprise. It also reduces the amount of manual processing that a developer needs to perform to keep abreast of these changes.

In conclusion to Section A, note that the topic-processing system 102 has been described for use by an enterprise in mining knowledge from the enterprise's document stores 106. But the topic-processing system 102 has wider applicability. For example, in another use, a search engine provider can use the topic-processing system 102 to extract relevant topics from a body of technical literature. The search engine provider can leverage the set of final topics in different ways. For example, the search engine provider can create an index that allows users to view and access documents related to specified topics. In addition, or alternatively, the search engine provider can highlight the identified topics in the documents. In addition, or alternatively, the search engine provider can use the identified topics in the same manner described in Subsection A.6, e.g., by providing supplemental information regarding topics to users in search results. In these applications, the search engine does not necessarily operate on behalf of an enterprise. Rather, it is directed to a target environment that is defined, in part, by a set of input documents having a specified scope. Different search engine providers can define the bounds of the document scope in any level of granularity, e.g., by including technical articles produced by plural publication sources or just a single journal or conference, etc.

B. Illustrative Processes

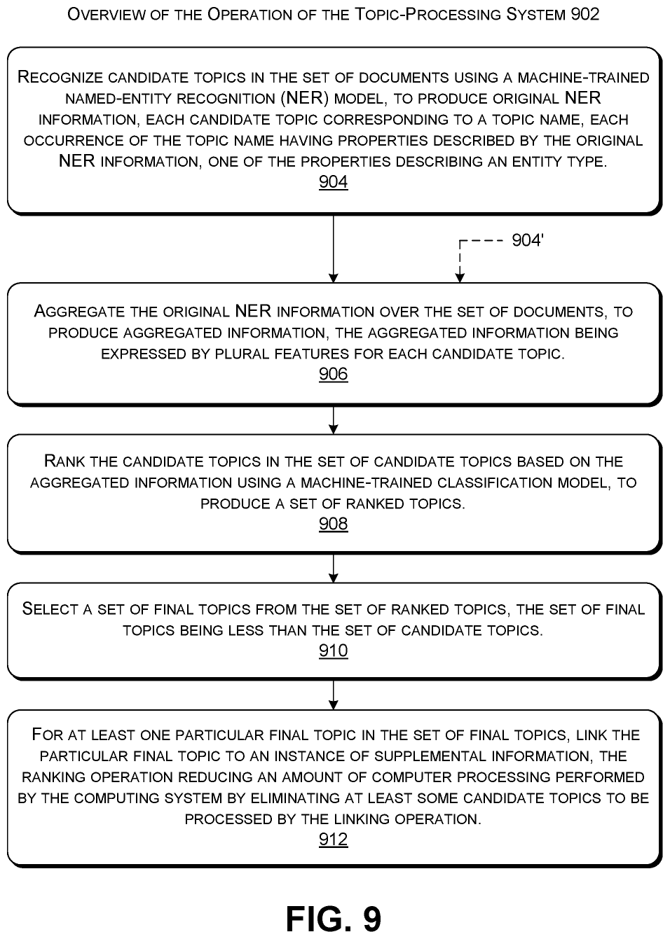

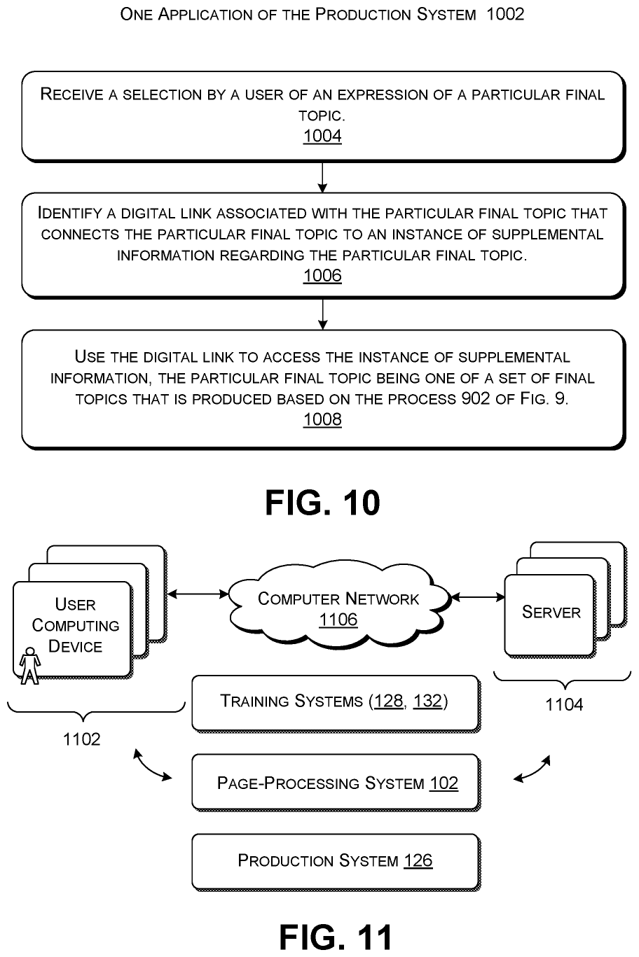

FIGS. 9 and 10 respectively show processes that explain the operation of the topic-processing system 102 and the production system 126 of Section A in flowchart form. Since the principles underlying the operation of the systems (102, 126) have already been described in Section A, certain operations will be addressed in summary fashion in this section. Each flowchart is expressed as a series of operations performed in a particular order. But the order of these operations is merely representative, and can be varied in other implementations. Further, any two or more operations described below can be performed in a parallel manner. In one implementation, the blocks shown in the flowcharts that pertain to processing-related functions can be implemented by the hardware logic circuitry described in Section C, which, in turn, can be implemented by one or more hardware processors and/or other logic units that include a task-specific collection of logic gates.

More specifically, FIG. 9 shows a process 902 performed by the topic-processing system 102 for processing topics in a set of documents 104. In block 904, the topic-processing system 102 recognizes candidate topics in the set of documents 104 using a machine-trained named-entity recognition (NER) model 130, to produce original NER information. Each candidate topic corresponds to a topic name. Further, each occurrence of the topic name has properties described by the original NER information, one of the properties describing an entity type. In block 906, the topic-processing system 102 aggregates the original NER information over the set of documents 104, to produce aggregated information, the aggregated information being expressed by plural features for each candidate topic. In block 908, the topic-processing system 102 ranks the candidate topics in the set of candidate topics based on the aggregated information using a machine-trained classification model 134, to produce a set of ranked topics. In block 910, the topic-processing system 102 selects a set of final topics from the set of ranked topics, the set of final topics being less than the set of candidate topics. In block 912, for at least one particular final topic in the set of final topics, the topic-processing system 102 links the particular final topic to an instance of supplemental information. The ranking operation (of block 908) reduces an amount of computer processing performed by the computing system by eliminating at least some candidate topics to be processed by the linking operation (of block 912).

Operation 904′ denotes obtaining the original NER information from the NER component 108. Overall, it is meant to describe a version of the process 902 that does not encompass generating the NER information, but rather obtaining it as input information.

FIG. 10 shows a process 1002, performed by the production system 126, for processing topics in a set of documents 104. In block 1004, the production system 126 receives a selection by a user of an expression of a particular final topic. In block 1006, the production system 126 identifies a digital link associated with the particular final topic that connects the particular final topic to an instance of supplemental information regarding the particular final topic. In block 1008, the production system 126 uses the digital link to access the instance of supplemental information. The particular final topic is one of a set of final topics that is produced based on process 902 of FIG. 9.

C. Representative Computing Functionality

FIG. 11 shows an example of computing equipment that can be used to implement any of the systems summarized above. The computing equipment includes a set of user computing devices 1102 coupled to a set of servers 1104 via a computer network 1106. Each user computing device can correspond to any device that performs a computing function, including a desktop computing device, a laptop computing device, a handheld computing device of any type (e.g., a smartphone, a tablet-type computing device, etc.), a mixed reality device, a wearable computing device, an Internet-of-Things (IoT) device, a gaming system, and so on. The computer network 1106 can be implemented as a local area network, a wide area network (e.g., the Internet), one or more point-to-point links, or any combination thereof.

FIG. 11 also indicates that the page-processing system 102, the production system 126, and the training systems (128, 132) can be spread across the user computing devices 1102 and/or the servers 1104 in any manner. For instance, in some cases, the production system 126 is entirely implemented by one or more of the servers 1104. Each user may interact with the servers 1104 via a browser application or other programmatic interface provided by a user computing device. In other cases, the production system 126 is entirely implemented by a user computing device in local fashion, in which case no interaction with the servers 1104 is necessary. In other cases, the functionality associated with the production system 126 is distributed between the servers 1104 and each user computing device in any manner.

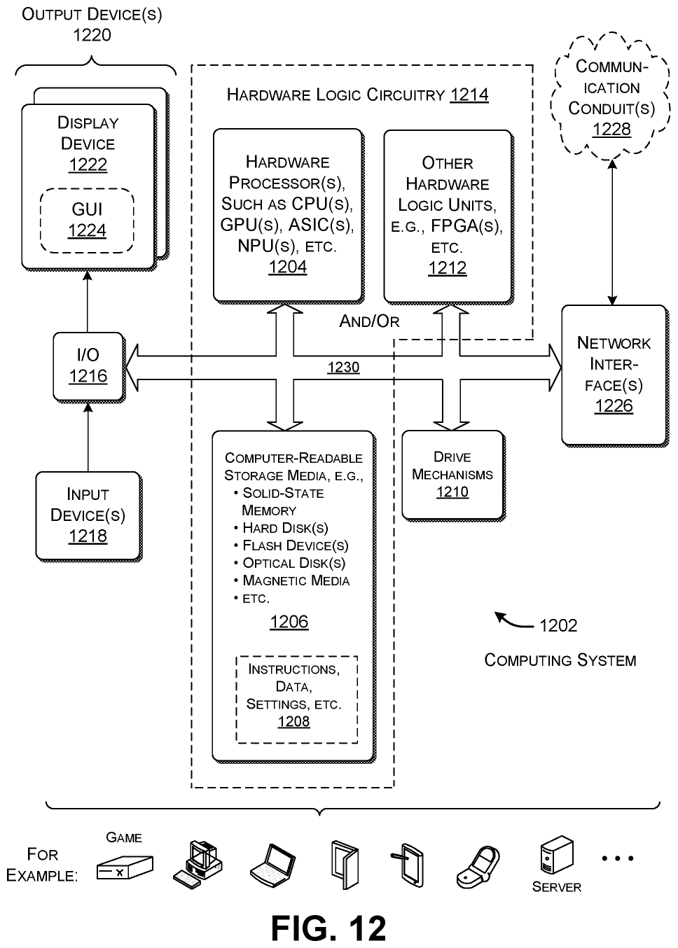

FIG. 12 shows a computing system 1202 that can be used to implement any aspect of the mechanisms set forth in the above-described figures. For instance, the type of computing system 1202 shown in FIG. 12 can be used to implement any user computing device or any server shown in FIG. 11. In all cases, the computing system 1202 represents a physical and tangible processing mechanism.

The computing system 1202 can include one or more hardware processors 1204. The hardware processor(s) 1204 can include, without limitation, one or more Central Processing Units (CPUs), and/or one or more Graphics Processing Units (GPUs), and/or one or more Neural Processing Units (NPUs), and/or one or more Application Specific Integrated Circuits (ASICs), etc. More generally, any hardware processor can correspond to a general-purpose processing unit or an application-specific processor unit.

The computing system 1202 can also include computer-readable storage media 1206, corresponding to one or more computer-readable media hardware units. The computer-readable storage media 1206 retains any kind of information 1208, such as machine-readable instructions, settings, data, etc. Without limitation, the computer-readable storage media 1206 may include one or more solid-state devices, one or more magnetic hard disks, one or more optical disks, magnetic tape, and so on. Any instance of the computer-readable storage media 1206 can use any technology for storing and retrieving information. Further, any instance of the computer-readable storage media 1206 may represent a fixed or removable unit of the computing system 1202. Further, any instance of the computer-readable storage media 1206 may provide volatile or non-volatile retention of information.

More generally, any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se in transit, while including all other forms of computer-readable media.

The computing system 1202 can utilize any instance of the computer-readable storage media 1206 in different ways. For example, any instance of the computer-readable storage media 1206 may represent a hardware memory unit (such as Random Access Memory (RAM)) for storing transient information during execution of a program by the computing system 1202, and/or a hardware storage unit (such as a hard disk) for retaining/archiving information on a more permanent basis. In the latter case, the computing system 1202 also includes one or more drive mechanisms 1210 (such as a hard drive mechanism) for storing and retrieving information from an instance of the computer-readable storage media 1206.

The computing system 1202 may perform any of the functions described above when the hardware processor(s) 1204 carry out computer-readable instructions stored in any instance of the computer-readable storage media 1206. For instance, the computing system 1202 may carry out computer-readable instructions to perform each block of the processes described in Section B.

Alternatively, or in addition, the computing system 1202 may rely on one or more other hardware logic units 1212 to perform operations using a task-specific collection of logic gates. For instance, the hardware logic unit(s) 1212 may include a fixed configuration of hardware logic gates, e.g., that are created and set at the time of manufacture, and thereafter unalterable. Alternatively, or in addition, the other hardware logic unit(s) 1212 may include a collection of programmable hardware logic gates that can be set to perform different application-specific tasks. The latter category of devices includes, but is not limited to Programmable Array Logic Devices (PALs), Generic Array Logic Devices (GALs), Complex Programmable Logic Devices (CPLDs), Field-Programmable Gate Arrays (FPGAs), etc.

FIG. 12 generally indicates that hardware logic circuitry 1214 includes any combination of the hardware processor(s) 1204, the computer-readable storage media 1206, and/or the other hardware logic unit(s) 1212. That is, the computing system 1202 can employ any combination of the hardware processor(s) 1204 that execute machine-readable instructions provided in the computer-readable storage media 1206, and/or one or more other hardware logic unit(s) 1212 that perform operations using a fixed and/or programmable collection of hardware logic gates. More generally stated, the hardware logic circuitry 1214 corresponds to one or more hardware logic units of any type(s) that perform operations based on logic stored in and/or otherwise embodied in the hardware logic unit(s). Further, in some contexts, each of the terms “component,” “module,” “engine,” “system,” “mechanism,” and “tool” refers to a part of the hardware logic circuitry 1214 that performs a particular function or combination of functions.

In some cases (e.g., in the case in which the computing system 1202 represents a user computing device), the computing system 1202 also includes an input/output interface 1216 for receiving various inputs (via input devices 1218), and for providing various outputs (via output devices 1220). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers, gyroscopes, etc.), and so on. One particular output mechanism may include a display device 1222 and an associated graphical user interface presentation (GUI) 1224. The display device 1222 may correspond to a liquid crystal display device, a light-emitting diode display (LED) device, a cathode ray tube device, a projection mechanism, etc. Other output devices include a printer, one or more speakers, a haptic output mechanism, an archival mechanism (for storing output information), and so on. The computing system 1202 can also include one or more network interfaces 1226 for exchanging data with other devices via one or more communication conduits 1228. One or more communication buses 1230 communicatively couple the above-described units together.

The communication conduit(s) 1228 can be implemented in any manner, e.g., by a local area computer network, a wide area computer network (e.g., the Internet), point-to-point connections, etc., or any combination thereof. The communication conduit(s) 1228 can include any combination of hardwired links, wireless links, routers, gateway functionality, name servers, etc., governed by any protocol or combination of protocols.

FIG. 12 shows the computing system 1202 as being composed of a discrete collection of separate units. In some cases, the collection of units corresponds to discrete hardware units provided in a computing device chassis having any form factor. FIG. 12 shows illustrative form factors in its bottom portion. In other cases, the computing system 1202 can include a hardware logic unit that integrates the functions of two or more of the units shown in FIG. 1. For instance, the computing system 1202 can include a system on a chip (SoC or SOC), corresponding to an integrated circuit that combines the functions of two or more of the units shown in FIG. 12.

The following summary provides a non-exhaustive set of illustrative examples of the technology set forth herein.

(A1) According to a first aspect, some implementations of the technology described herein include a method (e.g., the process 902 of FIG. 9), using a computing system (e.g., the computer system 1202 of FIG. 12), for processing topics in a set of documents (e.g., the documents 104 of FIG. 1). The method incudes recognizing (e.g., in block 904) candidate topics in the set of documents using a machine-trained named-entity recognition (NER) model (e.g., NER model 130), to produce original NER information. Alternatively, the method involves obtaining (e.g., in operation 1904′) the original NER information, but does not encompassing generating it. Each candidate topic corresponds to a topic name. Further, each occurrence of the topic name has properties described by the original NER information, one of the properties describing an entity type. The method also includes: aggregating (e.g., in block 906) the original NER information over the set of documents, to produce aggregated information, the aggregated information being expressed by plural features for each candidate topic; ranking (e.g., in block 908) the candidate topics in the set of candidate topics based on the aggregated information using a machine-trained classification model (e.g., classification model 134), to produce a set of ranked topics; and selecting (e.g., in block 910) a set of final topics from the set of ranked topics, the set of final topics being less than the set of candidate topics. The method also includes, for at least one particular final topic in the set of final topics, linking (e.g., in block 912) the particular final topic to an instance of supplemental information.

According to one technical characteristic, the ranking operation reduces an amount of computer processing performed by the computing system by eliminating at least some candidate topics to be processed by the linking operation.

(A2) According some implementations of the method of A1, the operation of ranking includes: in a first phase of ranking, ranking the candidate documents using a first set of features for each candidate topic; selecting a prescribed number of ranked topics produced by the first phase of ranking, to produce initial ranked topics; and in a second phase of ranking, ranking topics in the initial ranked topics using a second set of features, the second set of features being more descriptive compared to the first set of features.

(A3) According some implementations of the any of methods of A1 or A2, one feature of a particular topic name depends on a percentage of uppercase characters in the particular topic name.

(A4) According some implementations of the any of methods of A1-A3, one feature of a particular topic name depends on a number of entity types that are associated with the particular topic name, measured across the set of documents.

(A5) According some implementations of the any of methods of A1-A4, one feature of a particular topic name depends on a number of occurrences of a most-frequently-occurring entity type associated with the particular topic name, measured across the set of documents.

(A6) According some implementations of the any of methods of A1-A5, one feature of a particular topic name depends on a number of occurrences of plural entity types associated with the particular topic name, measured across the set of documents and across the plural entity types.

(A7) According some implementations of the any of methods of A1-A6, one feature for a particular topic name depends on a number of instances in which the particular topic name occurs in a title, measured across the set of documents.

(A8) According some implementations of the any of methods of A1-A7, one feature for a particular topic name depends on a number of documents in the set of documents that include the particular topic name.

(A9) According some implementations of the any of methods of A1-A8, a first feature for a particular topic name depends on a number of documents in the set of documents that include the particular topic name. A second feature for the particular topic name depends on a number of occurrences of plural entity types associated with the particular topic name, measured across the set of documents and for the plural entity types. A third feature for the particular topic name depends on a ratio of the first feature to the second feature.

(A10) According some implementations of any of methods of A1-A9, a first feature of a particular topic name depends on a number of occurrences of a most-frequently-occurring entity type associated with the particular topic name, measured across the set of documents. A second feature for the particular topic name depends on a number of occurrences of plural entity types associated with the particular topic name, measured across the set of documents and for the plural entity types. A third feature for the particular topic name depends on a ratio of the first feature to the second feature.

(A11) According some implementations of the any of methods of A1-A10, one feature for a particular topic name depends on an extent to which users have interacted with one or more documents that include the particular topic name.

(A12) According some implementations of the any of methods of A1-A11, one feature for a particular topic name depends on a timing at which users have interacted with one or more documents that include the particular topic name.

(A13) According some implementations of the any of methods of A1-A12, the supplemental information is a page of topic information regarding the particular final topic that is presented when a user selects a name associated with the particular final topic in a particular document.

(A14) According some implementations of any of methods of A1-A12, the supplemental information is information regarding the particular final topic that is presented when a user enters a query associated with the particular final topic into a search engine.

(A15) According some implementations of the any of methods of A1-A12, the supplemental information is information extracted from a knowledge base that is presented when the user makes a selection associated with the particular final topic.

(B1) According to another aspect, some implementations of the technology described herein include a method (e.g., the process 1002 of FIG. 10) for processing topics in a set of documents (e.g., documents 104 in FIG. 1). The method includes: receiving (e.g., in block 1004) a selection by a user of an expression of a particular final topic; identifying (e.g., in block 1006) a digital link associated with the particular final topic that connects the particular final topic to an instance of supplemental information regarding the particular final topic; and using (e.g., in block 1008) the digital link to access the instance of supplemental information. The particular final topic is one of a set of final topics that is produced based on any of the methods of A1-A12.

In yet another aspect, some implementations of the technology described herein include a computing system (e.g., computing system 1202) for processing a set of documents (e.g., the documents 104 of FIG. 1). The computing system includes hardware logic circuitry (e.g., the hardware logic circuitry 1214 of FIG. 12) that is configured to perform any of the methods of A1-A15 or B1. The hardware logic circuitry corresponding to: (a) one or more hardware processors (e.g., hardware processors 1204) that perform operations by executing machine-readable instructions (e.g., instructions 1208) stored in a memory (e.g., computer-readable storage media 1206), and/or (b) one or more other hardware logic units (e.g., hardware units 1212) that perform the operations using a task-specific collection of logic gates

In yet another aspect, some implementations of the technology described herein include a computer-readable storage medium (e.g., the computer-readable storage media 1206 of FIG. 12) for storing computer-readable instructions (e.g., instructions 1208). The computer-readable instructions, when executed by one or more hardware processors (e.g., hardware processors 1204), perform any of the methods described herein (e.g., methods A1-15 or B1).

More generally stated, any of the individual structural elements and steps described herein can be combined, without limitation, into any logically consistent permutation or subset. Further, any such combination can be manifested, without limitation, as a method, device, system, computer-readable storage medium, data structure, article of manufacture, graphical user interface presentation, etc. The technology can also be expressed as a series of means-plus-format elements in the claims, although this format should not be considered to be invoked unless the phase “means for” is explicitly used in the claims.

As to terminology used in this description, the phrase “configured to” encompasses various physical and tangible mechanisms for performing an identified operation. The mechanisms can be configured to perform an operation using the hardware logic circuitry 1114 of Section C. The term “logic” likewise encompasses various physical and tangible mechanisms for performing a task. For instance, each processing-related operation illustrated in the flowcharts of Section B corresponds to a logic component for performing that operation.

This description may have identified one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Further, the term “plurality” refers to two or more items, and does not necessarily imply “all” items of a particular kind, unless otherwise explicitly specified. Further, the descriptors “first,” “second,” “third,” etc. are used to distinguish among different items, and do not imply an ordering among items, unless otherwise noted. The phrase “A and/or B” means A, or B, or A and B. Further, the terms “comprising,” “including,” and “having” are open-ended terms that are used to identify at least one part of a larger whole, but not necessarily all parts of the whole. Finally, the terms “exemplary” or “illustrative” refer to one implementation among potentially many implementations.

In closing, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, using a computing system, for processing topics in a set of documents, comprising:
obtaining original name-entity recognition (NER) information from a machine-trained NER model, the NER model producing the original NER information by identifying candidate topics in the set of documents,
each candidate topic corresponding to a topic name, each occurrence of the topic name having properties described by the original NER information, one of the properties describing an entity type;
aggregating the original NER information over the set of documents, to produce aggregated information, the aggregated information being expressed by plural features for each candidate topic;
ranking the candidate topics in the set of candidate topics based on the aggregated information using a machine-trained classification model, to produce a set of ranked topics;
selecting a set of final topics from the set of ranked topics, the set of final topics being less than the set of candidate topics; and
for at least one particular final topic in the set of final topics, linking the particular final topic to an instance of supplemental information,
said ranking reducing an amount of computer processing performed by the computing system by eliminating at least some candidate topics to be processed by said linking.

2. The method of claim 1, wherein said ranking includes:
in a first phase of ranking, ranking the candidate documents using a first set of features for each candidate topic;
selecting a prescribed number of ranked topics produced by the first phase of ranking, to produce initial ranked topics; and
in a second phase of ranking, ranking topics in the initial ranked topics using a second set of features, the second set of features being more descriptive compared to the first set of features.

3. The method of claim 1, wherein one feature of a particular topic name depends on a percentage of uppercase characters in the particular topic name.

4. The method of claim 1, wherein one feature of a particular topic name depends on a number of entity types that are associated with the particular topic name, measured across the set of documents.

5. The method of claim 1, wherein one feature of a particular topic name depends on a number of occurrences of a most-frequently-occurring entity type associated with the particular topic name, measured across the set of documents.

6. The method of claim 1, wherein one feature of a particular topic name depends on a number of occurrences of plural entity types associated with the particular topic name, measured across the set of documents and across the plural entity types.

7. The method of claim 1, wherein one feature for a particular topic name depends on a number of instances in which the particular topic name occurs in a title, measured across the set of documents.

8. The method of claim 1, wherein one feature for a particular topic name depends on a number of documents in the set of documents that include the particular topic name.

9. The method of claim 1,
wherein a first feature for a particular topic name depends on a number of documents in the set of documents that include the particular topic name,
wherein a second feature for the particular topic name depends on a number of occurrences of plural entity types associated with the particular topic name, measured across the set of documents and for the plural entity types, and
wherein a third feature for the particular topic name depends on a ratio of the first feature to the second feature.

10. The method of claim 1,
wherein a first feature of a particular topic name depends on a number of occurrences of a most-frequently-occurring entity type associated with the particular topic name, measured across the set of documents,
wherein a second feature for the particular topic name depends on a number of occurrences of plural entity types associated with the particular topic name, measured across the set of documents and for the plural entity types, and
wherein a third feature for the particular topic name depends on a ratio of the first feature to the second feature.

11. The method of claim 1, wherein one feature for a particular topic name depends on an extent to which users have interacted with one or more documents that include the particular topic name.

12. The method of claim 1, wherein one feature for a particular topic name depends on a timing at which users have interacted with one or more documents that include the particular topic name.

13. The method of claim 1, wherein the supplemental information is a page of topic information regarding the particular final topic that is presented when a user selects a name associated with the particular final topic in a particular document.

14. The method of claim 1, wherein the supplemental information is information regarding the particular final topic that is presented when a user enters a query associated with the particular final topic into a search engine.

15. The method of claim 1, wherein the supplemental information is information extracted from a knowledge base that is presented when the user makes a selection associated with the particular final topic.

16. A computing system for processing topics in a set of documents, comprising:
hardware logic circuitry, the hardware logic circuitry corresponding to: (a) one or more hardware processors that perform operations by executing machine-readable instructions stored in a memory, and/or (b) one or more other hardware logic units that perform the operations using a task-specific collection of logic gates, the operations including:
receiving a selection by a user of an expression of a particular final topic;
identifying a digital link associated with the particular final topic that connects the particular final topic to an instance of supplemental information regarding the particular final topic; and
using the digital link to access the instance of supplemental information,
the particular final topic being one of a set of final topics that is produced based on a noise-reducing selection process that includes:
recognizing candidate topics in the set of documents using a machine-trained named-entity recognition (NER) model, to produce original NER information,
each candidate topic corresponding to a topic name, each occurrence of the topic name having properties described by the original NER information, one of the properties describing an entity type;
aggregating the original NER information over the set of documents, to produce aggregated information, the aggregated information being expressed by plural features for each candidate topic;
ranking the candidate topics in the set of candidate topics based on the aggregated information using a machine-trained classification model, to produce a set of ranked topics; and
selecting a set of final topics from the set of ranked topics, the set of final topics being less than the set of candidate topics,
said ranking reducing a number of digital links between expressions of final topics and respective instances of supplemental information.

17. The computing system of claim 16, wherein one particular feature of a particular topic name depends on one or more of:
at least one lexical characteristic of the particular topic name; and/or
a distribution of different entity types that are associated with the particular topic name, measured across the set of documents; and/or
a number of documents in the set of documents that include the particular topic name; and/or
a manner in which users have interacted with the documents that include the particular topic name.

18. The computing system of claim 16, wherein the expression of the particular final topic is a particular name that appears in a particular document, and wherein the supplemental information is a page of topic information regarding the particular final topic that is presented when the user selects the particular name in the particular document.

19. The computing system of claim 16, wherein the expression of the particular final topic is a particular query, and wherein the supplemental information is information regarding the particular final topic that is presented when a user enters the particular query into a search engine.

20. A computer-readable storage medium for storing computer-readable instructions, the computer-readable instructions, when executed by one or more hardware processors, performing a method that comprises:
obtaining original name-entity recognition (NER) information from a machine-trained NER model, the NER model producing the original NER information by identifying candidate topics in a set of documents,
each candidate topic corresponding to a topic name, each occurrence of the topic name having properties described by the original NER information, one of the properties describing an entity type;
aggregating the original NER information over the set of documents, to produce aggregated information, the aggregated information being expressed by plural features for each candidate topic;
ranking the candidate topics in the set of candidate topics based on the aggregated information using a machine-trained classification model, to produce a set of ranked topics; and
selecting a set of final topics from the set of ranked topics, the set of final topics being less than the set of candidate topics,
said ranking eliminating at least some candidate topics to be subsequently processed by the computer-readable instructions.
